(19) United States
(12) Patent Application Publication
(10) Pub. No.: US 2021/0138308 A1
(43) Pub. Date: May 13, 2021

(54) SPORTS BALL HAVING ELECTRONICS AND METHOD FOR MAKING

(71) Applicant: Nicolas San Juan, American Fork, UT (US)

(72) Inventor: Nicolas San Juan, American Fork, UT (US)

(21) Appl. No.: 17/074,625

(22) Filed: Oct. 19, 2020

Related U.S. Application Data
(63) Continuation-in-part of application No. 16/403,548, filed on May 5, 2019.
(60) Provisional application No. 62/669,260, filed on May 9, 2018.

(51) Int. Cl. A63B 43/00; A63B 41/02; A63B 71/06

(52) U.S. Cl. CPC A63B 43/004; A63B 41/02; A63B 71/0622; B29C 65/48; A63B 2209/00; A63B 2225/50; A63B 2071/0625; A63B 2220/833

(57) ABSTRACT

A sports ball may include a bladder having one or more pockets attached thereto wherein the pockets have holes for allowing air to escape the pockets. The pockets may include insert(s) such as sensors, a battery or a microprocessor. The pockets may also include one or more damping members to further protect the insert(s).

### BACKGROUND

### State of the Art

The present invention relates to a sports ball having electronics. More specifically, the present invention relates to sports balls which have electronics to assist in monitoring the performance of users of the ball.

### Field of Art

With the growing popularity of sports, there has been an increase in the use of monitoring equipment to help improve training of athletes. Various wearable sensors are used by athletes and those attempting to lose weight to track heart rate, distance walked, stairs climbed, and calories burned. While such sensors are able to track the physical exertion of the person being monitored, they generally cannot tell if an athlete is performing a sport properly. For example, while the sensors will tell the physical level at which the athlete is performing, it will not tell if the athlete is dribbling, kicking or throwing a ball properly.

Efforts have been made to obtain enhanced information by placing sensors within a ball used in athletics. For example, U.S. Pat. No. 9,662,556 teaches an electronic sports tracking and coaching system which includes a ball with a variety of electronics, such as accelerometers, gyroscope and other sensors. The sensors can be used to monitor force, spin, and flight time of the ball. This information can then be coordinated with sensors worn by an athlete to determine the athlete's skill in performing a particular part of the sport. For example, the sensors can determine the speed of rotation of a football to determine if a quarterback is properly executing the release of the football to have a tight spiral.

In addition to sensors, U.S. Pat. No. 9,662,556 teaches the use of a speaker in the outside of the ball which may be used to provide instructions and feedback to the athlete. For example, the speaker may indicate when something was executed well or how improvement can be made.

While U.S. Pat. No. 9,662,556 provides a marked improvement in monitoring, the design of the ball as shown in the patent has drawbacks. The speaker is shown as being outside the ball where it can be damaged. Also, the sensors are susceptible to damage as the ball is repeatedly kicked, thrown, hit, etc. Thus, there is a need for an improved sports ball having electronics and a method of using the same.

There have been numerous attempts to create sports balls that include sensors. In some cases, the sensors are placed in the lining, and in other cases the sensors are placed between layers of the bladder. While it is believed by some that positioning the sensors in the bladder is advantageous, this can be more difficult to perform in actual practice. In order to get layers of rubber, butyl, latex or similar materials to bind together, they typically go through a vulcanizing process where the material is heated to between 300 and 400 degrees. This allows the materials to essentially melt together so that the pieces of material will not come apart.

One problem which occurs during vulcanization, however, is that any air disposed between the pieces of rubber, etc., will expand due to the heat. This leaves bubbles in the bladder and results in quality control issues.

Another problem with many sports balls is that the sensors disposed therein can be damaged when the ball is kicked, hit, etc. Thus, there is a need to develop a process which improves manufacturing and reduces the risk of sensors, microprocessors, etc., being damaged.

### SUMMARY OF THE INVENTION

The following summary of the present invention is not intended to describe each illustrated embodiment or every possible implementation of the invention, but rather to give illustrative examples of application of principles of the invention.

In some configurations, the invention may comprise of a ball having a bladder and one or more circuits or microprocessors attached to or embedded in the bladder. The bladder may hold the microprocessor(s) in place and prevent it (them) from moving around within the ball while the ball is being hit, kicked, thrown, etc.

In accordance with one aspect of the present disclosure, the bladder also has one or more batteries attached to or embedded on or disposed therein. The battery may be held in place by the bladder and an independent wire, or a lead formed on the bladder may connect the battery to the microprocessor to provide power to the microprocessor.

In accordance with another aspect of the present disclosure, a charging element, such as an inductive charging coil, may be attached to the bladder. The charging element may be disposed in electrical communication with the batteries, such as by an independent wire or by a lead formed on the bladder, and configured so that no external sockets or ports are necessary in order to generate electricity in the charging element and thereby recharge the batteries.

In accordance with another aspect of the present disclosure, a speaker may be attached to or embedded in the bladder. The speaker may be configured so that a portion of the speaker is disposed outside the enclosure formed by the bladder, but within the general sphere created by the bladder. This may include the speaker not extending beyond the general sphere or other shape created by the bladder when pressurized with air. Additionally, the outer layer of the ball may have holes to conduct sound out of the ball when the speaker is used.

In accordance with another aspect of the present disclosure, the bladder may include at least one weighting structure which may have a weight approximately the same of that of a battery, charging element, microprocessor, or speaker. The weighting structure may be formed from the material which makes the bladder, or may be attached to or embedded in the bladder.

In accordance with still yet another aspect of the present disclosure, the battery, charging element, microprocessor, speaker, etc. may be positioned within the bladder so as to minimize imbalance in the ball. Thus, for example, if a battery, charging element, microprocessor and speaker were being used, the different inserts may be disposed at approximately 109.5 degrees from a center point within the bladder, effectively forming the points of a tetrahedron. In contrast, if six inserts are used, each insert would be disposed at approximately a 90-degree angle from the closest four inserts and on the opposite side of the other insert. In such a manner, the weight of each insert tends to offset the other inserts and allows a ball to be used with little difference in performance from a conventional sports ball.

In accordance with yet another aspect of the present disclosure, a plurality of sensors may be disposed at various locations around the ball. The sensors may include accelerometers or other sensors which can measure changes in force or impact. By positioning multiple sensors around the ball, the sensors can be used to determine where the ball was kicked, hit, etc., as the location closest to the point of impact will detect greater force than a more remote portion. Multiple sensors can also be used to determine the spin rate of the ball, orientation of the ball on impact and other desired information.

In accordance with another aspect of the present disclosure, the ball may include transmitters or transceivers which communicate with a remote node, which may be for example a hub device running hub server software or a Wi-Fi access point or other communications protocol which allows the information from one or more balls to be transmitted to a device having a screen for viewing data received from the ball so that coaches, etc., can monitor the progress of the athlete.

In accordance with another aspect of the invention, a pocket is formed by attaching a piece of the bladder material (typically rubber, butyl or latex or similar material) to the bladder to form a pocket with the sensor, etc., disposed in the pocket. The pocket is formed with one or more holes to allow air to escape the pocket during the vulcanization process.

In accordance with another aspect of the invention, the material used to form the pocket is pre-formed with channels to receive electrical conducting material to transmit signals and power to/from the sensors.

In accordance with another aspect of the invention, the material may have a circular channel formed therein for disposing a generally circular wire wrapped to form an induction coil for charging a battery within the sports ball.

In accordance with another aspect of the invention, a number of straps are formed along the bladder to hold wires passing between sensors, microprocessors and batteries. The wires are left loose and curved on either side of the straps to allow the wire to move without placing stress on the wire or on the bladder.

It will be appreciated that various embodiments of the invention may not include each aspect set forth above and aspects discussed above shall not be read into the claims unless specifically set forth therein.

### BRIEF DESCRIPTION OF THE DRAWINGS

Various embodiments of the present disclosure are shown and described in reference to the numbered drawings wherein:

FIG. 1 illustrates a side cross-sectional view of a sports ball disposed on a charging station in accordance with teachings of the present disclosure;

FIG. 2 shows a bladder having a plurality of inserts attached thereto;

FIG. 3 shows another sports ball made in accordance with the present disclosure;

FIG. 4 shows yet another configuration of a sports ball made in accordance with the present disclosure;

FIG. 5 shows a view of a system utilizing sports balls as described above and further including a hub for collecting feedback from multiple balls and for conveying the information to one or more remote devices, such as a computer, a tablet or a smart phone;

FIG. 6 shows another sports ball made in accordance with the present disclosure; and

FIG. 7 shows a communications system for monitoring the data received from the balls;

FIG. 8 shows an alternate communications system for monitoring data received from the balls.

FIG. 9 shows a top view of a pocket formed and a sports ball bladder;

FIG. 10 shows a side view of multiple pockets being attached to a flattened bladder, along with the straps and electrical wires;

FIG. 11 show a side-cross-sectional view of a sensor disposed in the pocket;

FIG. 12 shows a bottom view of the material forming a pocket for attachment to the bladder; and

FIG. 13 shows a bottom view of a pocket formed for receiving coiled wire in order to form an induction coil.

It will be appreciated that the drawings are illustrative and not limiting of the scope of the invention, which is defined by the appended claims. The embodiments shown accomplish various aspects and objects of the invention. It will be appreciated that it is not possible to clearly show each element and aspect of the present disclosure in a single figure, and as such, multiple figures are presented to separately illustrate the various details of different aspects of the invention in greater clarity. Similarly, not all configurations or embodiments described herein or covered by the appended claims will include all of the aspects of the present disclosure as discussed above.

### DETAILED DESCRIPTION

Various aspects of the invention and accompanying drawings will now be discussed in reference to the numerals provided therein so as to enable one skilled in the art to practice the present invention. The skilled artisan will understand, however, that the methods described below can be practiced without employing these specific details, or that they can be used for purposes other than those described herein. Indeed, they can be modified and can be used in conjunction with products and techniques known to those of skill in the art in light of the present disclosure. The drawings and the descriptions thereof are intended to be exemplary of various aspects of the invention and are not intended to narrow the scope of the appended claims. Furthermore, it will be appreciated that the drawings may show aspects of the invention in isolation, and the elements in one figure may be used in conjunction with elements shown in other figures.

Reference in the specification to “one embodiment,” “one configuration,” “an embodiment,” or “a configuration” means that a particular feature, structure, or characteristic described in connection with the embodiment may be included in at least one embodiment, etc. The appearances of the phrase “in one embodiment” in various places may not necessarily limit the inclusion of a particular element of the invention to a single embodiment, rather the element may be included in other or all embodiments discussed herein.

Furthermore, the described features, structures, or characteristics of embodiments of the present disclosure may be combined in any suitable manner in one or more embodiments. In the following description, numerous specific details may be provided, such as examples of products or manufacturing techniques that may be used, to provide a thorough understanding of embodiments incorporating aspects of the invention. One skilled in the relevant art will recognize, however, that embodiments discussed in the disclosure may be practiced without one or more of the specific details, or with other methods, components, materials, and so forth. In other instances, well-known structures, materials, or operations may not be shown or described in detail to avoid obscuring aspects of the invention.

Before the present invention is disclosed and described in detail, it should be understood that the present invention is not limited to any particular structures, process steps, or materials discussed or disclosed herein, but is extended to include equivalents thereof as would be recognized by those of ordinarily skill in the relevant art. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such aspect is required to be present apart from an express inclusion of that aspect in the claims.

It should also be noted that, as used in this specification and the appended claims, singular forms such as “a,” “an,” and “the” may include the plural unless the context clearly dictates otherwise. Thus, for example, reference to “a bracket” may include an embodiment having one or more of such brackets, and reference to “the target plate” may include reference to one or more of such target plates.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing the nearly all of the length of a lumen would be substantially enclosed, even if the distal end of the structure enclosing the lumen had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

As used herein, the term “generally” refers to something that has characteristics of a quality without being exactly that quality. For example, a structure said to be generally vertical would be at least as vertical as horizontal, i.e., would extend 45 degrees or greater from horizontal. Likewise, something said to be generally circular may be rounded like an oval but need not have a consistent diameter in every direction.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

Turning now to FIG. 1, there is shown a ball, generally indicated at 4. The ball 4 includes a cover 8, a lining 12 and a bladder 16. While the cover 8, the lining 12 and the bladder 16 would typically be disposed immediately adjacent one another, the outer two layers have been expanded outwardly to improve visualization of the bladder 16.

Embedded in or attached to the bladder are a plurality of inserts, preferably at least three and typically ranging from four to twelve. The inserts may include one or more batteries 20, one or more microprocessors or sensors 24, one or more charging elements 28, one or more speakers 32 and one or more weighting elements 36. As shown in FIG. 1, the battery 20 is attached to the bladder 12 and is attached electrically via electrical lines or leads 40 to a microprocessor 24 (which may also serve as a sensor and/or a transmitter or transceiver) and a charging element 28. When the ball 4 is placed on a charging stand 50 which is supplied power via a power cord 54, the charging station generates energy in the charging element 28 (typically formed by an inductive coil) which powers the batteries. Thus, there is no need to remove the batteries or to have a socket formed in the ball. Rather, the ball may be charged by simply placing it on the charging stand 50. To facilitate charging, the ball may have a marking that may be placed on the ball adjacent the charging element to ensure proper alignment on the stand 50.

As shown in FIG. 1, the wires 40 may be attached for redundancy. Thus, in the event one of the wires breaks or pulls loose from the charging element 28, the battery 20, the microprocessor 24 or the speaker 32, the ball 4 will still be able to function as desired. It will also be appreciated that some functions may be performed without wires, such as by Bluetooth or other wireless communication between the microprocessor 24 and the speaker 32 and/or between the microprocessor (transceiver) and some external receiver or transceiver. Likewise, the microprocessor 24 may communicate with structures such as computers, mobile phones data gathering devices and the like using Wi-Fi, Bluetooth, near field communications and other wireless protocols.

The microprocessor 24 may include a variety of sensors, such as one or more accelerometer, one or more gyroscope and other sensors which can be used to determine the force with which the ball 4 is kicked, hit or thrown, as well as other factors such as time of flight, spin (which can indicate if the kick is proper) and force on impact when the ball lands. These different readings can be assembled together to determine, or at least approximate depending on the processing power of the microprocessor and accuracy of the sensors, how hard the ball was kicked, etc., whether it was done properly, and whether the ball landed near a target zone indicated by a post, etc. The microprocessor may process the data received, or the data may be sent out via a wireless signal to a remote microprocessor which can analyze the data and convert it into usable form. Thus, for example, when a soccer player is practicing a corner kick, the ball may provide information on how much spin the player was able to put on the ball and how close the ball came to the goal. A coach can then look at the information and determine what adjustments are necessary. For example, the athlete may be able to place the proper amount of spin on a soccer ball, but she may be routinely kicking the ball short of the goal. The coach can then work with the athlete to increase leg strength and kicking technique to improve placement.

Likewise, a young basketball player may have sufficient strength to project the basketball above the rim, but may lack consistency in making free-throws because he is not putting enough spin on the ball to ensure a consistent path of travel. Rather than requiring a coach to stand there watching the player shoot free throw after free throw, the present invention allows the coach to observe a larger data set and determine things to watch for. For example, the basketball player may have hit the top of the rim 95 out of 100 times, but the ball shows very little rotation. The coach can promptly determine that arm strength is not the issue, but rather the release of the ball to apply the proper spin. After teaching the proper technique, the coach can check back 15 minutes later and determine whether the athlete has made the proper adjustments.

As shown in FIG. 1, the various inserts may be equally spaced around the bladder, so that they balance one another. The battery 20 is spaced opposite the weight 36 and the charging element 28 is disposed opposite the microprocessor 24. If a complete ball were shown, another battery, microprocessor, speaker or insert may be spaced opposite speaker 32 to provide balance to the ball, thereby preventing the sensors from altering the path of the ball when it is hit, kicked, thrown, etc. When six sensors or other inserts are used in a round ball, the sensors may be disposed substantially opposite from one another so as to form the ends of X, Y and Z axes passing through the middle of the ball. If one of the inserts weighs more than the others, the position of the remaining inserts can be adjusted to compensate for the weight, or weights may be added to keep the weight relatively consistent within the ball. For example, if the charging element 28 were twice the weight of the other inserts, the inserts to the side of the charging element could be moved toward the microprocessor to achieve a more balanced weight. Alternatively, weighting material could be used adjacent each lighter insert to balance the ball.

If other numbers of sensors are used, a different geometric disposition could be used. For example, if four inserts were to be used, the inserts could be disposed at the ends of a tetrahedral shape so they are equally spaced apart. Also, as used herein the term insert suggests something embedded in or attached to the bladder 16. It will also be appreciated that a weight could be formed by simply having a much thicker area in the wall of the bladder, such as a spot where the bladder wall is 5 or more times as thick as the bladder wall over most of its surface, to thereby provide a weight that helps balance the ball.

Turning now to FIG. 2, there is shown a bladder 16 having a battery 20, a microprocessor 24, a speaker 32 and a weighting portion 36, along with fragmented pieces of the liner 12 and cover 8. The battery 20 is disposed in communication with the microprocessor 24 and the speaker 32 via wires 40 or leads.

The wires 40 may also pass through the weighting portion 36 if desired, though the weighting portion 36 may be either thickened bladder wall or some other weighting material added to balance the ball. Because having the speaker 32 disposed inside the wall of the bladder would tend to interfere with a user hearing what is broadcasting from the speaker, the bladder may include one or more pockets 60 or depressions. As shown in FIG. 2, pockets 60a are recessed into the bladder 16, but are open to the outside. In this manner, the speaker 32 and microprocessor 24 (or battery, etc.) can be within the general volume of the bladder (i.e., the outer circumference of the bladder if the pockets were not there) where the inserts are protected from impact with the liner (12, FIG. 1) and cover (8, FIG. 1) of the ball, but may still be accessible from the outside if needed. Alternatively, the ball 4 could have a battery disposed in one of the pockets in alignment with a small hole in the cover of the ball so that the battery could be recharged by a small power jack (such as micro-usb head or even a single, double, etc. prong charger so that the ball could be recharged in the field without needing a wireless charger.

Likewise, a plurality of holes 64 could be formed in the liner 12 and the cover 8 so as to facilitate the transfer of sound out of the ball. Because the bladder 16 is typically made from an elastic material like rubber, etc., the structure forming the pockets 60 will tend to dampen vibrational energy developed by kicking, bouncing, hitting or throwing the ball, while preventing the inserts from bouncing around inside the bladder 16. The speaker 32 and/or wires can be glued in place to prevent any air escaping from the bladder 16 via holes around the wires 40.

The other pockets 60 and the weighting portion 36 can be formed on the inside of the bladder 16 during the molding process. The battery and other internal inserts, along with the wires, can be added prior to inversion of the bladder before it is sealed and filled with air. Thus, depending on the desired use of the ball 4, the ball can be constructed so some parts are accessible or at least can be heard clearly outside the bladder 16.

Turning now to FIG. 3, there is shown a top view of a sports ball, generally indicated at 4. The sports ball 4 has one or more holes 64 in the outer cover 8 to allow sound from a speaker 32 to be heard outside the ball and/or to provide a small recharging port which is recessed in the ball so it would not injure an athlete even if struck with the ball at that location.

The ball 4 may also include one or more each of a microprocessor 24, a battery 20 and a charging element 28. While the microprocessor may have one or more accelerometers and/or gyroscopes disposed thereon, it will also be appreciated that such components could simply be sensors which are physically separate from the microprocessor and may communicate via wires of a wireless protocol such as Wi-Fi or Bluetooth.

Turning now to FIG. 4, there is shown a cross-sectional view of a ball 4 having an alternate layout of the inserts. The ball 4 may include a charging element 28, a battery 20, a speaker 32 and a microprocessor or sensors 24. The microprocessor 24 may include a data gathering and processing unit 24a, along with a memory 24b, and/or a receiver or transceiver 24c. If provided, the memory 24b may record information obtained by data gathering and processing unit 24a. In this may be, for example, the amount of force applied to the ball 4, any amount of spin detected after the ball was impacted, and the time until the next impact may be sensed by one or more of an accelerometer 24d, a gyroscope 24e and the data correlated with data from a timekeeping element 24f. By correlating this data, an estimate may be obtained about how far the ball 4 traveled from the point of impact until contacting the ground, etc., or how quickly a basketball player was dribbling. This information may be conveyed by an audibly perceptible signal sent via the speaker 32, or may be sent to a remote device by the transceiver 24c. In such a manner, the player is able to receive feedback on his or her performance and comparisons can be made as to whether the player is improving on a particular skill over a given period of time. For example, repeated kicks can be monitored to see if the player is getting more power into the ball and thereby causing the ball to travel further. Likewise, objective data can be recorded as to whether the player is able to develop spin on the ball so as to cause the ball to curve toward a desired location. Data can be recorded and compared to new data to document improvement, continued need to work on a skill, or whether a player is actually making modifications which are bringing undesirable results.

As shown in FIG. 4, the inserts 20, 24, 28 and 32 are spread out so as to be evenly spaced around the sphere and effectively form a tetrahedron between them. In such a configuration the ball remains balanced provided that each of the inserts is approximately the same weight.

FIG. 5 shows a view of a system, generally indicated at 68, utilizing sports balls 4 as described above and further including a hub 70. The hub 70 may contain a transceiver or other wireless communication device which conveys information relating to the ball 4 to a remote location where it may be processed and visualized by a coach or player. For example, the hub 70 may be in communication with a smart phone 78, a tablet 82, and/or a computer 86. Likewise, the hub 70 and/or the ball 4 may be in communication with wireless headphones 90 so that information may be sent wirelessly to the headphones. The headphones may be worn by the player kicking the ball, etc., or worn by a coach who can monitor input received from the ball 4 or the hub 70. Information may be conveyed to the player, such as: “You are not getting enough spin on the ball. Try kicking the ball a little further to the outside.” The player can then attempt to make the adjustments and the data sets developed will record whether he or she was able to make the improvements.

As shown in FIG. 5, the hub 70 may be used as part of an exercise to determine the location of a ball relative to a desired location or may contain sensors to simply indicate if the ball has crossed the goal line. For example, in soccer it is desirable to kick the ball into the goal as close as possible to one of the corners, thereby making it more difficult for the goalie to intercept the ball. In FIG. 5 hubs have been placed in the upper right, upper left and lower left corners of the goal 74. A player may be given an exercise wherein he or she is told to kick the ball as close as possible to the upper right corner of the goal. As the ball is kicked, not only can the hub 70 pass data regarding the force applied to the ball and any spin, etc., the hub may also be able to detect how close the ball has come to the hub, thereby providing information on how accurately the player was able to kick the ball correlated with speed of the ball. Thus, while one player may need to work on his or her accuracy and placement of the ball, another player may need to work on the velocity of the ball, as both speed and placement are critical to scoring goals in soccer.

Multiple hubs may be used together to allow them to triangulate the position of the ball. For example, a plurality of hubs 70 could be placed on a football field (not shown in FIG. 5). A kicker could attempt to kick a football at a point equidistant from the hubs (e.g., near the sideline inside the 5-yard line). The hubs 70 could then indicate how close the kicker came to placing the ball in the desired location. The ball 4 may continuously broadcast information regarding force applied spin, etc. or the information may be stored in memory and provided only in response to a communication from the hub 70, etc. The hub 70 may communicate the information provided by the ball 4 to the smart phone 78, the tablet 82, the computer 86, and/or the wireless headphones 90. The hub may also record the information associated with the ball and may simply forward the data to one of the processing devices 78, 82, 86 and/or 90 which can put the data in more human perceptible form.

It will be appreciated that the hub 70 may communicate with multiple different devices about multiple different balls 4. Additionally, the hub may correlate information related to a player, such as may be present due to a sensor worn by the player or disposed in the wireless headphones so that player's progress may be tracked regardless of which ball he or she is using at the time. This could be accomplished, for example, by the ball detecting via Bluetooth, etc. that player 1 is engaging the ball. All of the data for the ball over the next 10 seconds could be correlated with player 1, unless the ball detects another player is engaging the ball, in which case the data would then start being applied to player 2, etc. Thus, for example, in a shooting drill player 1 may kick the ball. Player 2, the goalie, may impact the ball and the ball did not cross into the goal, indicating a save by the goalie. Player 3 may then engage the ball and score a goal. After repeated attempts a coach may determine that the goalie is doing a good job of stopping the initial kick, but deflecting the ball in such a manner than it places him at risk for being scored on by another player. The present system allows a coach to obtain and consider a substantial amount of data which may provide answers not readily discernable from watching each player for a few minutes during practice.

Turning now to FIG. 6, there is show a bladder 16. The bladder may be covered with a touch-sensitive material 44, or may simply be covered with a cover and lining (not shown). The bladder 16 may include a number of inserts such as a charging element 28, a battery 20, a speaker 32 and one or more microprocessors or sensors 24. Among the inserts may be one or more data gathering and processing unit 24a, memory 24b, and/or a receiver or transceiver 24c. If provided, the memory 24b may record information obtained by data gathering and processing unit 24a in the event that the transceiver and hub are out of range or otherwise unable to communicate the data in real time via the desired communications protocol. The recorded data may include, for example, the amount of force applied to the ball, any amount of spin detected after the ball was impacted, and the time until the next impact was sensed.

The bladder 16 may include a plurality of accelerometers 24d, or gyroscopes 24e and the data collected may be correlated with data from a timekeeping element 24f. By correlating this data, an estimate may be as to location at which the player's foot impacted the ball, the amount of spin generated, the time of flight of the ball and thus the likely distance traveled. The microprocessors may be programmed to relate the information in multiple languages—either to assist coaches and players having different language abilities or to help players learn relevant terminology in another language. Thus, a soccer player from Mexico could learn the terminology of the game in French while practicing to facilitate coaching from French speaking coaches or to play soccer games in France.

Turning now to FIG. 7, there is shown a single hub 70 which may run hub server software. The balls 4 communicate with the hub 70 via an APi. The hub 70, in turn, can communicate with a plurality of client devices, such as one or more smart phones 78, tablets 82 and/or the wireless headphones 90, via Wi-Fi or some other communications protocol.

In FIG. 8 the system may simply use a ball APi communicated over Wi-Fi, Bluetooth, etc. to convey the data. The transfer of information could occur in real time or could be stored on the ball 4 and then downloaded when one of the smart phones 78, tablets 82 and/or the wireless headphones 90 is within range.

Turning now to FIG. 9, there is shown a fragmented top view of a pocket 60 formed on a sports ball bladder 16. A plurality of wires 40 extend out of the pocket 60 for connecting different sensors (not shown), a microprocessor (not shown) and a power source (not shown). While attempts have been made to dispose the sensors in between layers of the bladder, it has been found that during the vulcanization process (i.e., heating the material to bond layers of the bladder together) the air within the pocket expands. This leaves air bubbles between layers of the bladder and can result in the sensors being held less securely. As shown in FIG. 9, the pocket 60 includes a piece of rubber (or rubber like material) 102 which has been formed with a void (See FIGS. 11 through _) to receive a sensor, battery, microprocessor, etc. The piece of rubber 102 includes a flange 116 along which it is adhesively attached to the bladder 16. To prevent air bubbles from forming, the piece of rubber 102 includes one or more holes to allow air to vent out of the pocket 60 during vulcanization. This allows for more secure holding of the insert, whether it be a battery, microprocessor, sensor, etc.

FIG. 10 shows a side fragmented view of multiple pockets 60 being attached to a flattened bladder 16. In addition to the pieces of rubber 102 being attached to the bladder 16, a plurality of straps 104 are bonded to the bladder between the pockets. The straps 104 are preferably attached so that the wires 40 can slide within the strap. Additionally, the wires 40 are preferably left long enough that they curve on each side of the straps 104. This allows the ball to be deformed by kicking, hitting, etc., without the wires 40 placing pressure on the straps, and/or on the sensors, etc., within the pockets 60. This helps to prolong the life of the wire 40 and the strap 104 even under repeated flexing due to the ball impacting a player's feet, hands, head or the ground.

FIG. 11 shows a cross-sectional view taken through one of the pockets 60 wherein the piece of rubber 102 has been fused to the bladder 16 along the flange 116. The pockets 60 may be formed with a void which is large enough to receive damping materials to lessen the impact on the insert, such as a microprocessor 28. The damping materials may include a first layer of a more rigid foam 120 and a second layer of a softer or more compliant foam 126. The softer or more compliant foam 126 is typically disposed adjacent the microprocessor 28, etc., and the more rigid foam 120 is usually disposed adjacent a wall of the pocket 60. While shown as only having the foam on one side, it will be appreciated that the microprocessor 28, etc. can also be sandwiched between layers of foam or other damping material.

When the ball is kicked adjacent the pocket 60, the damping materials 120, 126 act together to lessen the impact to the microprocessor 28 or other sensor, battery, etc., disposed within the pocket 60. This allows the insert to serve a longer useful life.

FIG. 12 shows a bottom view of the piece of rubber or rubber like material 102 forming a pocket for attachment to the bladder (not shown). The piece of material 102 may be formed so as to have a void 124 for receiving the microprocessor, sensor, battery, etc. Holes 100 may be formed to allow hot air to escape from the pocket as the piece of material is bonded along the flange 116 to the bladder (not show). The flange 116 may also be pre-formed with channels 112 to facilitate the entry of wires (not shown) into and out of the pocket.

During the manufacturing process, the insert and damping material may be inserted into the void 124 in the piece of material 102 and the flange 116 may be coated with an adhesive and attached to the bladder. The bladder is then subjected to a vulcanization or other bonding process, wherein the bladder, piece of material 102 and its components may be heated to between 300- and 400-degrees Fahrenheit, and most commonly about 360 degrees. This allows the pieces of rubber or other similar material to fuse or bond together to thereby minimize the risk of the piece of material 102 detaching from the bladder during use. As the air expands, it is able to vent out of the pocket by the holes 100 in the piece of material 102.

Turning now to FIG. 13, there is shown a bottom view of another piece of material 102 forming a pocket 60. The pocket has a generally cylindrical void 124 into which a coiled wire 40 is placed. The coiled wire 40 acts at an induction coil and allows a current to be developed in the wire which recharges a battery (not shown). Thus, none of the electrical wires 40 need to extend outside the bladder in order to recharge the battery.

In use, the piece of material 102 is placed on the bladder (not show) with the wire inside and then is subject to the vulcanizing or bonding process. The flange 116 bonds to the bladder and air expansion of air within the pocket is alleviated by the hole 100 in the piece of material 102.

While discussed herein primarily relating to a soccer ball, those of skill in the art will appreciate that the principles discussed herein can be used with any sports ball containing a bladder, including, but not limited to, basketballs, dodge balls footballs, rugby balls, volleyballs, etc. It is intended that any references in the claims cover such balls unless expressly excluded by the claim language.

Thus, there is disclosed a sports ball having electronics and method of making the same. It will be appreciated that numerous modifications may be made without departing from the scope and spirit of this disclosure. The appended claims are intended to cover such modifications.

1. A bladder having at least one pocket bonded thereto, the pocket being formed from a piece of material having a hole formed therein.

2. The bladder of claim 1, wherein the pocket includes a sensor.

3. The bladder of claim 2, wherein the pocket includes a damping material.

4. The bladder of claim 3, wherein the damping material comprises foam.

5. The bladder of claim 4, wherein the damping material comprises a first layer of foam and a second layer of foam, the first layer being softer than the second layer.

6. The bladder of claim 1, wherein the piece of material has a flange formed therein.

7. The bladder of claim 6, wherein the flange has a channel formed therein.

8. The bladder of claim 1, further comprising a plurality of straps bonded to the bladder and wire extending through the strap.

9. The bladder of claim 8, wherein the wire attaches to a pocket formed on the bladder and wherein the length of wire between the strap and the pocket is longer than a distance between the strap and the pocket such that the wire is curved.

10. The bladder of claim 1, wherein the piece of material has a generally cylindrical void formed therein.

11. The bladder of claim 10, further comprising a wire coiled disposed in the generally cylindrical void.

12. The bladder of claim 1, wherein the piece of material is pre-formed with a void.

13. A method for making a bladder for a sports ball, the method comprising:
selecting a bladder;
selecting a piece of material having a hole formed therethrough;
placing at least one insert into the void;
adhesively attaching the piece of material to the bladder; and
heating the bladder and piece of material to bond the piece of material to the bladder.

14. The method according to claim 13, wherein the piece of material is formed to have a flange and a void and therein the piece of material is adhesively attached to the void.

15. The method according to claim 13, wherein the method further comprises placing a first damping member in the pocket adjacent the insert.

16. The method according to claim 15, wherein the method comprises placing a second damping member in the pocket adjacent the first damping member.

17. The method according to claim 16, wherein the first damping member and the second damping member have different rigidities.
